(19) United States
(12) Patent Application Publication
(10) Pub. No.: US 2007/0102100 A1
(43) Pub. Date: May 10, 2007

(54) Method of manufacturing vehicle front frame

(75) Inventor: Kuo-Pin Yu, Taichung (TW)

Correspondence Address: BROWDY AND NEIMARK, P.L.L.C.;624 NINTH STREET, NW, SUITE 300, WASHINGTON, DC, 20001-5303, US

(73) Assignee: Yuan Min an Enterprise Co., Ltd., Taichung (TW)

(21) Appl. No.: 11/270,557

(22) Filed: Nov. 10, 2005

(51) Int. Cl. B29C 53/58

(52) U.S. Cl. 156/189

(57) ABSTRACT

A method of manufacturing a vehicle front frame includes wrapping a pre-preg around a mandrel and curing the pre-preg to form an upright tube. Secondly, winding two pre-pregs into two elongated tubes and connecting a middle portion of each of the two elongated tubes with an end of the upright tube. Then placing the upright tube and the two elongated tubes into a die. Inflating the two elongated tubes to make the two elongated tubes abut on the inner wall of the die, and curing the two elongated tubes to form a front fork that joins the upright tube. The manufacturing method has a simple operating process. In addition, the product made by the method has improved mechanical strength.

### BACKGROUND OF THE INVENTION

1. Field of the Invention

The present invention relates to a vehicle and more particularly to such a method of manufacturing a vehicle front frame. The method is easy to operate. The product of the manufacturing method has improved mechanical strength.

2. Description of the Related Art

A conventional vehicle, such as bicycle, scooter or tri-cycle, is made of metal, such as aluminum alloy. For reducing weight, the vehicle adopts the fiber reinforcing material recently. The front portion of the bicycle frame has a front frame having an upright tube and a front fork extended downward from the bottom of the upright tube. The upright tube is used for mounting a steering handlebar and bearings. A front wheel is pivotally mounted on the bottom of the front fork.

A conventional manufacturing method of a vehicle front frame comprises winding two pre-pregs into two elongated tubes. The two elongated tubes are placed into a die for curing. The upper sections of the two elongated tubes are bonded to form the upright tube. There is a middle rib inside of the upright tube therefore. The lower sections of the two elongated tubes are separated to form the front fork. The upright tube is used for mounting the steering handlebar and bearings. The inner wall and the outer wall of the upright tube need to be trimmed to form a true circle section for assembly. The middle rib of the upright tube has to be cut off for the same reason. The manufacturing process is difficult to operate and time-consuming. The fiber structure is broken due to the process and the mechanical strength is reduced dramatically. In addition, the conjunction of the upright tube and the front fork where the two elongated tubes are bent doesn't have enough mechanical strength. The structure of this point is easily damaged due to stress concentration.

### SUMMARY OF THE INVENTION

The primary objective of the present invention is to provide a method of manufacturing a vehicle front frame, which is easy to operate.

Another objective of the present invention is to provide a method of manufacturing a vehicle front frame, which the product made by the method has improved mechanical strength.

The present invention has been accomplished under the circumstances in view. The present invention is to provide a method of manufacturing a vehicle front frame. The first step is to wrap a pre-preg around a mandrel and then curing the pre-preg to form an upright tube. Secondly, winding two pre-preg into two elongated tubes and connecting a middle portion of each of the two elongated tubes with an end of the upright tube. Thirdly, placing the upright tube and the two elongated tubes into a die, inflating the two elongated tubes to make the two elongated tubes abut on an inner wall of the die, and curing the two elongated tubes to form a front fork that joins the upright tube.

### BRIEF DESCRIPTION OF THE DRAWINGS

FIG. 1 is a schematic view of step (a) according to a preferred embodiment of the present invention.

FIG. 2 is a schematic view of step (b) according to the preferred embodiment of the present invention.

FIG. 3 is a schematic view of step (c) according to the preferred embodiment of the present invention.

FIG. 4 is a perspective view of a product according to the preferred embodiment of the present invention.

FIG. 5 is a sectional view taken along line 5-5 of FIG. 4.

FIG. 6 is a sectional view taken along line 6-6 of FIG. 4.

FIG. 7 is a schematic view of a vehicle front frame according to another preferred embodiment of the present invention.

### DETAILED DESCRIPTION OF THE INVENTION

A method of manufacturing a vehicle front frame 22 in accordance with the preferred embodiment of the present invention comprises the following three steps:

Step (a)

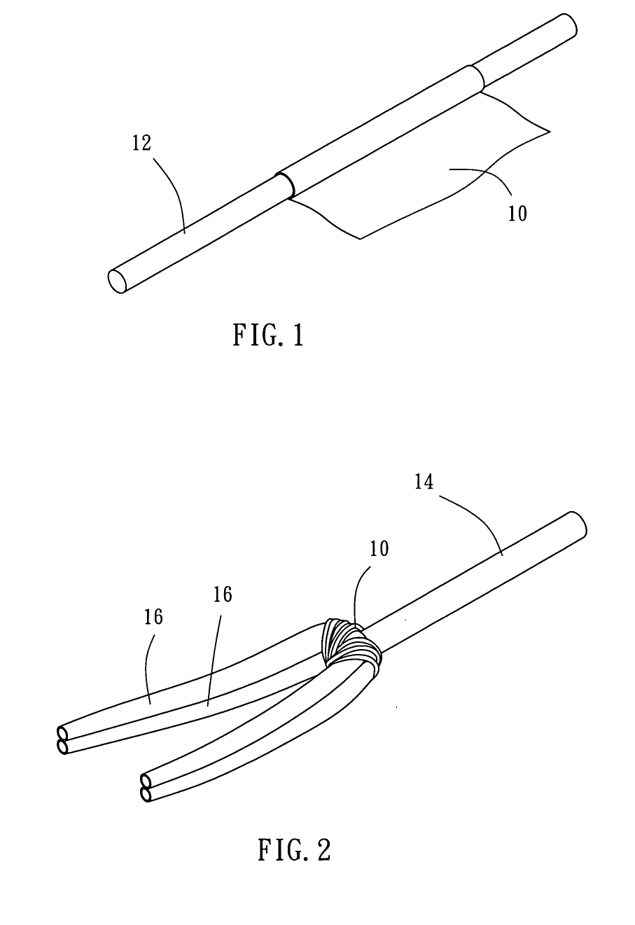

Wrapping a pre-preg 10 around a mandrel 12, as shown in FIG. 1. Then heating and curing the pre-preg a predetermined period of time to form an upright tube 14. The mandrel 12 is a rod having uniform diameter, so the inner wall of the upright tube 14 approximates a true circle. The pre-preg 10 is wound layer by layer. Thus, the outer wall of the upright tube 14 approximates a true circle, too. The inside of the upright tube 14 has no middle rib as described in the conventional upright tube. The upright tube 14 only needs to be trimmed slightly before assembly. Most of the fiber structure of the upright tube is conserved to avoid lost of mechanical strength. The resin used in the pre-preg adopts, and is not limited to, epoxy, thermosetting resin etc. The fiber adopts, and is not limited to, carbon fiber, glass fiber, boron fiber, Kevlar fiber etc.

Step (b)

Winding two pre-preg 10 into two elongated tubes 16 and connecting a middle portion of each of the two elongated tubes 16 with a bottom end of the upright tube 14. The two elongated tubes and the upright tube are connected with each other by wrapping a pre-preg 10 thereon, as shown in FIG. 2. At this time, the upright tube 14 is cured, while the two elongated tubes 16 are not cured.

Step (c)

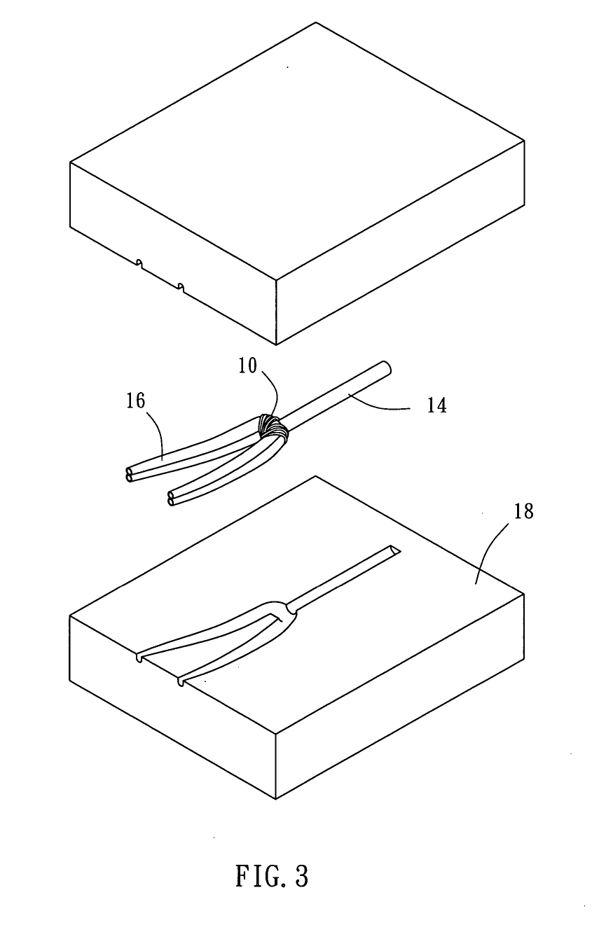

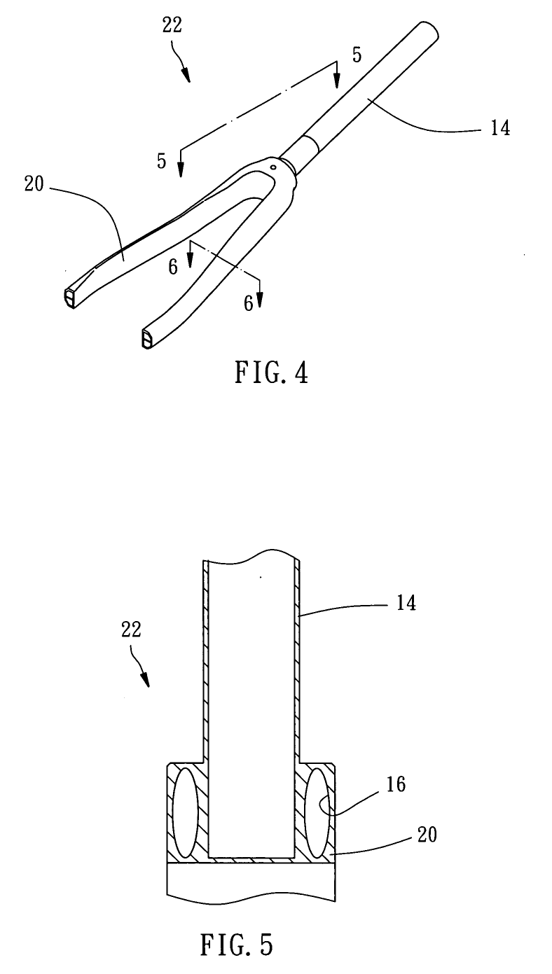

Placing the upright tube 14 and the two elongated tubes 16 into a die 18, as shown in FIG. 3. Inflating the two elongated tubes 16 to make the two elongated tubes 16 abut on an inner wall of the die 18. Curing the two elongated tubes 16 to form a front fork 20 which joins the upright tube 14, as shown in FIGS. 4-6. Thereby finishing the main procedure of manufacturing the front frame 22.

In the front frame 22 made by the manufacturing method in accordance with the preferred embodiment of the present invention, the inner wall and outer wall of the upright tube 14 approximate a true circle. The upright tube 14 only needs to be trimmed slightly before assembly. The operation process is simpler than that of the conventional manner, and the damage to the fiber structure is much smaller relatively. The whole mechanical strength of the front frame 22 is improved relative to the product of the conventional method.

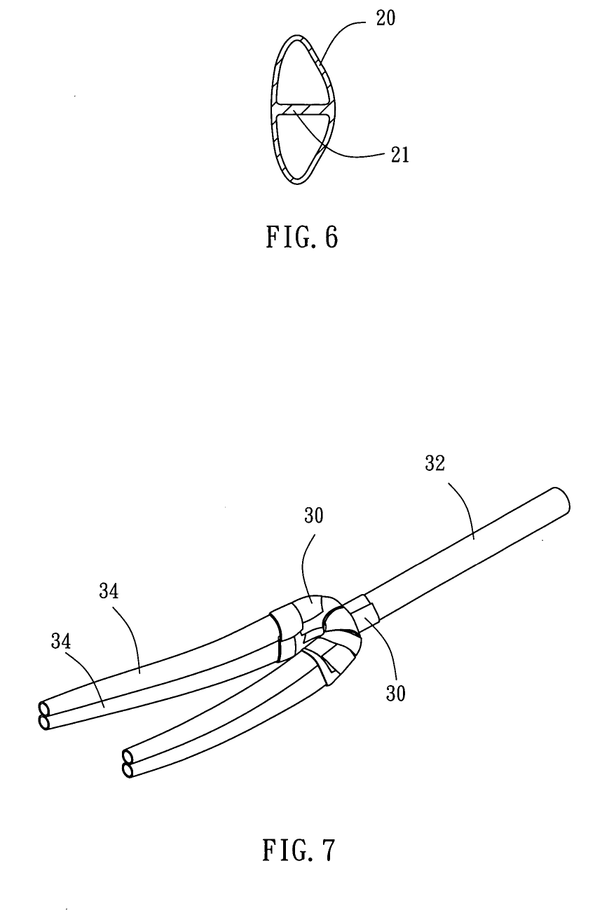

In addition, the conjunction of the two elongated tubes 16 and the upright tube 14 is wrapped by piles of pre-preg 10 thereon to strengthen the strength of the connection of the two elongated tubes 16 and the upright tube 14. There is no damage at the conjunction of the two elongated tubes 16 and the upright tube 14 after a long time test. Besides, as shown in FIG. 6, the front fork 20 is composed of the two elongated tubes 16, so that the front fork 20 has a middle rib 21 to enhance the whole mechanical strength of the front frame 22. The front frame 22 made by the method of the present invention has a longer lifetime. Without affecting the strength, the front frame 22 can be design to have a lighter weight.

In practice, the two elongated tubes 16 and the upright tube 14 are wrapped by the pre-preg 10. Alternatively, as shown in FIG. 7, the pre-preg is cut into multiple bonding sheets 30 having predetermined sizes. The two elongated tubes 34 and the upright tube 32 are connected with each other by attaching the bonding sheets thereon.

What is claimed is:

1. A method of manufacturing a vehicle front frame comprising:
(a) wrapping a pre-preg around a mandrel and then curing the pre-preg to form an upright tube;
(b) winding two pre-pregs into two elongated tubes and connecting a middle portion of each of the two elongated tubes with an end of the upright tube; and
(c) placing the upright tube and the two elongated tubes into a die, inflating the two elongated tubes to make the two elongated tubes abut on an inner wall of the die, and curing the two elongated tubes to form a front fork which joins the upright tube.

2. The method of manufacturing a vehicle front frame as claimed in claim 1, wherein the two elongated tubes and the upright tube are connected with each other by wrapping a pre-preg thereon.

3. The method of manufacturing a vehicle front frame as claimed in claim 1, wherein the two elongated tubes and the upright tube are connected with each other by attaching a pre-preg thereon.
